(19) United States
(12) Patent Application Publication
(10) Pub. No.: US 2026/0075503 A1
(43) Pub. Date: Mar. 12, 2026

(54) MASKING OF NETWORK FUNCTION TOPOLOGY FOR VISITING CONSUMERS WITHIN A 5G NETWORK

(71) Applicant: Oracle International Corporation, Redwood City, CA (US)

(72) Inventors: Virendra Singh, Bengaluru (IN); Uri Baniel, Buffalo Grove, IL (US); Shashikiran Mahalank, Bengaluru (IN)

(21) Appl. No.: 18/826,839

(22) Filed: Sep. 6, 2024

(51) Int. Cl. H04W 40/24; H04L 41/12

(52) U.S. Cl. CPC H04W 40/248; H04L 41/12

(57) ABSTRACT

Various embodiments of the present technology generally relate to systems and methods for providing an inter-domain engine for masking communications exchanged between a visitor network and a home network. In an aspect, the inter-domain engine may be part of a home network and determine a service request from a visitor consumer NF. Based on the service request, the inter-domain engine may determine a service response containing NF topology information for furnishing the service request within the home network. Responsive to determining the service response, the inter-domain engine may generate a mask NF profile based on the service response and generate a mask service response based on the mask NF profile and the service request. Once generated, the inter-domain engine may provide the mask service response to the visitor network.

### TECHNICAL FIELD

Various embodiments of the present technology generally relate to network function communication within 5G networks. More specifically, embodiments of the present technology relate to systems and methods for providing an inter-domain engine for masking network function (NF) topology during routing of visiting consumer requests within a 5G network.

### BACKGROUND

In a typical 5G Core (5GC) inter-PLMN (Public Land Mobile Network) routing scenario, consumer Network Functions (NFs) and producer NFs often reside in different domains. These domains could represent different PLMNs, such as when a user is roaming between networks operated by different mobile service providers. For example, when a subscriber from one PLMN (the home network) travels and connects to another PLMN (the visited network), the consumer NFs (those initiating requests for services) may belong to the visited network, while the producer NFs (those providing the requested services) remain within the home network. Alternatively, these domains might be Non-Public Networks (NPNs), which are typically deployed for private use by enterprises or industries, or they could represent different regional entities within the same PLMN, reflecting how large operators organize their infrastructure across multiple geographic areas. This multi-domain architecture is essential for enabling seamless connectivity and service continuity, allowing users to experience consistent network performance and access services regardless of their location or the underlying network provider. By facilitating inter-domain communication between NFs, the 5GC supports a flexible and scalable network environment capable of meeting the diverse needs of modern mobile communications.

However, during these scenarios, the Home PLMN (H-PLMN) might prefer not to share its own 5GC network's NF topology information with the Visiting PLMN (V-PLMN). This reluctance stems from concerns overexposing sensitive information, such as the load and capacity details of candidate producer NFs. Revealing such data could compromise the H-PLMN's network security and operational integrity, as it may provide the V-PLMN or third parties with insights into the H-PLMN's network capabilities, potentially leading to competitive disadvantages or security vulnerabilities. To avoid these risks, the H-PLMN may prefer to perform NF selection and routing within its home network, ensuring that it maintains control over its network resources and protects its strategic interests.

Despite the security concerns, current approaches to inter-PLMN routing often necessitate the disclosure of NF topology information between the H-PLMN and the V-PLMN. Under existing methodologies, effective routing and service delivery require both PLMNs to have a clear understanding of each other's network functions, including the topology of NFs within the H-PLMN. This sharing is essential for enabling the V-PLMN to efficiently route service requests to the appropriate NFs within the H-PLMN. Without this information, the V-PLMN would face challenges in accurately directing traffic and ensuring service continuity for roaming users. As a result, the H-PLMN may be compelled to disclose details about its NF topology, including the locations and capabilities of its producer NFs, to facilitate seamless inter-PLMN communication. However, this practice inherently increases the risk of exposing sensitive information, making it a point of tension between the need for operational efficiency and the imperative to protect network integrity.

Accordingly, there exists a need for improved systems and techniques for inter-PLMN routing that allows for NF topology hiding and NF selection and routing by the home network. In particular, there is a need for an inter-domain engine that can furnish a service request from a V-PLMN (e.g., visitor service request) without disclosing the NF topology of the H-PLMN. As will be described in greater detail below, the inter-domain engine may also manage NF selection and routing for visitor service requests within the home network to avoid disclosure of NF profile information to the V-PLMN. Accordingly, the inter-domain engine allows the H-PLMN to safeguard its infrastructure while still supporting inter-PLMN communication and service continuity.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing an inter-domain engine that masks NF topology of a home network when routing requests from visitor networks within a 5G environment. As will be described in greater detail below, an inter-domain engine may be part of or in operational communication with a Security Edge Protection Proxy (SEPP) of a home network. As such, when a service request is received from a visitor network, such as from a visitor consumer network function (NF) within the visitor network, the inter-domain engine may mask a respective service response generated by the home network prior to routing it to the visitor network.

As will be described in greater detail below, when a service request is received from a visitor network, the inter-domain engine may determine a service response based on the service request. This may include routing the service request to a respective NF within the home network and receiving the service response from the respective NF. Once the inter-domain engine receives the service response, the inter-domain engine may mask the service response. In particular, the inter-domain engine may mask any NF topology information included in the service response. To mask the NF topology information, the inter-domain engine may generate a mask NF profile based on the service response. As part of the mask NF profile, the inter-domain engine may use endpoint information for an associated SEPP such that the visitor network routes subsequent communications to the home network's SEPP, instead of a respective NF within the home network.

Using the mask NF profile, the inter-domain engine may generate a mask service response based on the service response. For example, the mask service response may include a header and/or endpoint information that indicates that the visitor network should route subsequent information to the SEPP. Once generated, the inter-domain engine via the SEPP may provide the mask service response to the visitor network.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a 5G network in which one or more features of an inter-domain engine can be implemented, according to an embodiment herein;

FIG. 2 illustrates an example operational flow of a visitor network requesting services from a home network, according to an embodiment herein;

FIG. 3 illustrates an operational environment 300 in which an inter-domain engine masks communication exchanges between a visitor network and a home network, according to an embodiment herein;

FIG. 4 provides an example inter-domain engine process, according to an embodiment herein;

FIG. 5 illustrates an example operational flow for providing an inter-domain engine, according to an embodiment herein;

FIG. 6 illustrates another example operational flow for providing an inter-domain engine, according to an embodiment herein; and

FIG. 7 shows an example computing device suitable for providing an inter-domain engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

The utilization of 5G networks is rapidly becoming ubiquitous and indispensable in modern society. With its promise of ultra-fast speeds, low latency, and massive connectivity, 5G technology is transforming the way we communicate, work, and live. From streaming high-definition content on mobile devices to powering autonomous vehicles and smart cities, the potential applications of 5G are virtually limitless. Businesses are leveraging 5G networks to enable remote work, enhance productivity, and drive innovation across various industries. Additionally, the proliferation of Internet of Things (IoT) devices, coupled with 5G's capacity to support a massive number of connected devices, is fueling the growth of smart homes, healthcare systems, and industrial automation. As 5G networks continue to expand and evolve, they are increasingly relied upon to deliver seamless connectivity and enable the next wave of technological advancements, shaping the future of society in profound ways.

Roaming, the ability for client devices to move between networks, or different domains within the same network, without impacting service, is an increasingly vital feature of 5G. This seamless connectivity ensures that users experience consistent high-speed data, low latency, and uninterrupted service regardless of their geographic location. The sophisticated infrastructure of 5G supports advanced roaming capabilities, allowing devices to transition smoothly between different network operators and regions. This is particularly beneficial for international travelers, remote workers, and IoT applications that require constant connectivity. Enhanced roaming capabilities also enable innovative services such as real-time language translation and global telemedicine, further underscoring the importance of ubiquitous, reliable network access in our interconnected world.

When a client device roams between different networks or domains, the visited network, which is referred to herein as the “home network,” plays a crucial role in facilitating seamless connectivity and maintaining service continuity. To achieve this, the home network often shares relevant information about its network functions with the visiting or visitor network. For example, when a client device moves to a new network, the visitor network may send a discovery request to the home network. This request seeks detailed information about the home network's network functions (NFs) and their topology. In response, the home network provides a discovery response that includes comprehensive NF topology information, such as the locations and capabilities of various network functions (e.g., AMF, SMF, UDM). This exchange of information allows the visitor network to efficiently route signaling and user data, ensuring that the client device remains connected and receives uninterrupted service across different network domains.

Response transmitted between the home network and the visitor network often include sensitive information about the home network. For example, responses, such as discovery or service responses often include details about the NF topology, providing the visitor network with information on the locations and functions of various network elements such as the Access and Mobility Management Function (AMF), Session Management Function (SMF), and Unified Data Management (UDM), along with their IP addresses or identifiers. Responses can also include service capabilities, outlining the specific services and features available within the home network, such as authentication, authorization, policy control, and data management. Additionally, the response may cover interworking requirements, specifying any protocols or security measures necessary for interoperability between the networks. Finally, network performance metrics may be provided in responses, offering insights into performance characteristics and network load that could impact the roaming experience, such as latency and bandwidth availability. This comprehensive information enables the visitor network to manage the client device's sessions effectively, ensuring a seamless and high-quality user experience throughout the roaming period.

While sharing sensitive information with the visitor network is essential for effective roaming and service management, it may be undesirable for the home network for several reasons. Firstly, disclosing detailed network function topology and service capabilities can expose the home network to potential security risks. Unauthorized access or misuse of this information could lead to vulnerabilities, such as targeted attacks on critical network elements or exploitation of service capabilities. Additionally, sharing operational and performance data may inadvertently reveal insights into the home network's performance characteristics and internal policies, which could be leveraged by competitors or malicious actors to gain a strategic advantage. Privacy concerns also arise, as the dissemination of data about user behavior and network interactions could infringe on user confidentiality and regulatory compliance requirements. Furthermore, managing and safeguarding this information involves administrative overhead and potential legal liabilities, as the home network must ensure that sensitive data is protected in accordance with data protection laws and agreements. Consequently, while sharing such information is necessary for seamless service, it requires careful consideration and robust security measures to mitigate these risks.

Accordingly, to allow for seamless connectivity and service continuity for a visiting consumer, an example inter-domain engine is provided herein. The inter-domain engine provided herein may mask NF topology for communication exchanges with visiting consumers with a 5G network and, in some cases, handle NF selection and/or routing within the home network to ensure that these processes are performed via the home network policies and configurations. By masking NF topology and other NF information that is sensitive to the home network, the inter-domain engine facilitates effective roaming and service management without disclosing sensitive information of the home network with the visitor network, thereby limiting exposure of the home network to security risks and privacy concerns.

As will be described in greater detail below, the inter-domain engine may be part of a home network, in particular part of a home Security Edge Protection Proxy (hSEPP). Responsive to determining a service response or request from a NF within a home network, the inter-domain engine may generate a mask NF profile based on the service response or request. For example, if the service response is a discovery response generated by the home Network Repository Function (hNRF), the discovery response may include various NF topology information, such as NF profile properties associated with respective NFs available to furnish a received discovery request. To prevent exposure of such NF topology information, the inter-domain engine may generate a mask NF profile that includes similar NF profile properties except replacing the content with its own endpoints and information.

As the home network interacts with the visitor network, the inter-domain engine may generate mask responses/requests to prevent exposure of the NF information with the visitor network. Using a mask NF profile, the inter-domain engine may map a respective communication exchanged with the visitor network with the mask NF profile such that as subsequent communications are exchanged, the inter-domain engine can identify related requests/responses such to process the subsequent communications appropriately. For example, responsive to sending a masked discovery response to the visitor network, the home network may receive a subsequent service request. Using the respective NF mask profile to the service request, the inter-domain engine may identify the associated domain response that identifies NFs available to furnish the service request. As will be described in greater details below, the inter-domain engine may route the service request to an appropriate NF for furnishing the service request.

By masking the NF topology and related information the inter-domain engine provides significant benefits over conventional approaches. For example, the inter-domain engine enhances security within the home network by minimizing the exposure of internal network details to external entities, reducing the risk of potential attacks or unauthorized access. The inter-domain engine also allows the home network to maintain control over its internal operations, ensuring that sensitive information, such as NF configurations and statuses, remains confidential. Furthermore, by performing NF selection internally, the inter-domain engine allows the home network to optimize resource allocation and ensure that service requests are handled by the most appropriate NFs, leading to improved performance, efficiency, and service quality. Overall, the inter-domain engine simplifies inter-network interactions by abstracting the complexity of the home network's architecture from the visitor network, thereby streamlining service provision and reducing the potential for interoperability issues.

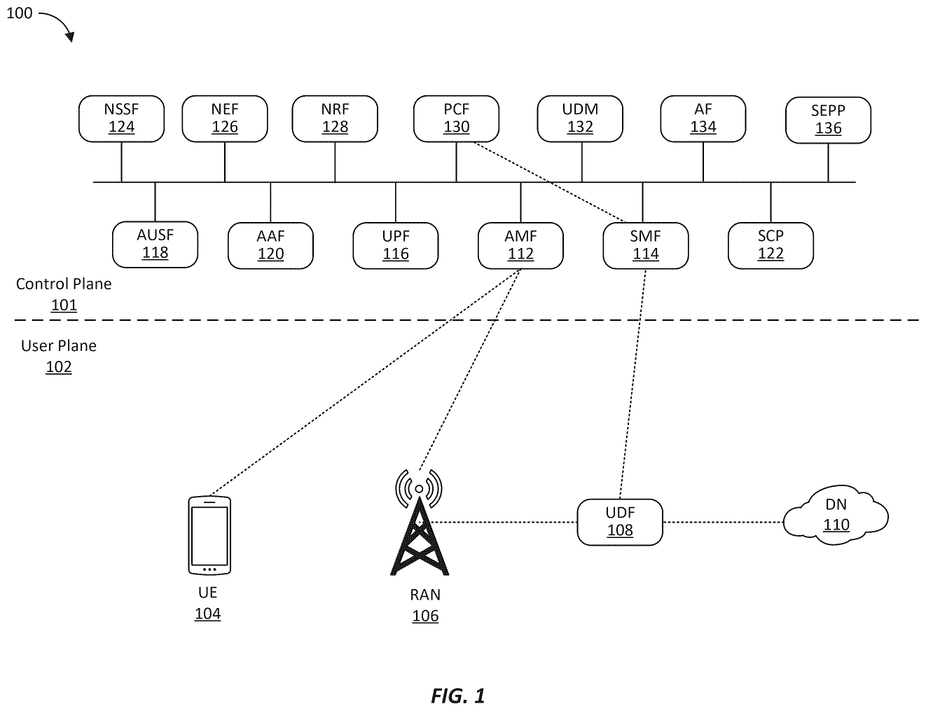

Turning now to the Figures, FIG. 1 illustrates an example operational environment for a 5G network 100 in which one or more features of an inter-domain engine can be implemented, according to an embodiment herein. The example 5G network 100 is a 5G core (5GC) cellular network implementing 3GPP (3rd Generation Partnership Project) communication standards, although the present disclosure may apply to other communication networks.

The 5G network 100, its components, and their sub-components may be implemented via computers, servers, hardware and software modules, or other system components. The components of the 5G network 100 and its subcomponents, or the physical devices implementing them, may be co-located, remotely distributed, or any combination thereof. The elements of 5G network 100 may include components hosted or situated in the cloud and implemented as software modules potentially distributed across one or more server devices or other physical components.

The 5G network 100 is divided into two fundamental planes: a control plane 101 and a user plane 102, each serving distinct yet interdependent roles. The control plane 101 is responsible for managing the signaling and control information necessary to establish, modify, and terminate communication sessions. The control plane 101 handles tasks such as authentication, policy enforcement, and mobility management. As such, the control plane 101 is crucial for orchestrating and controlling the NFs, ensuring efficient and secure connectivity. On the other hand, the user plane 102 deals with the actual data transmission—the movement of user data between devices and applications. It is optimized for high-throughput, low-latency data delivery, and is designed to efficiently transport user traffic. The separation of the control plane 101 and user plane 102 in the 5G network 100 enhances scalability, flexibility, and enables network slicing, allowing tailored configurations to meet diverse service requirements. Together, these planes 101 and 102 form a cohesive architecture that empowers the 5G network 100 to deliver unprecedented speed, reliability, and versatility for a wide array of applications and services.

As noted above, the user plane 102 of the 5G network 100 operates in tandem with the control plane 101 to deliver efficient and seamless data transmission. For example, as illustrated, when a User Equipment (UE) 104, which could be a smartphone or any other device, initiates a communication the user plane 102 handles the actual user data traffic. When the UE 104 initiates communication, the Radio Access Network (RAN) 106 comes into play, managing the wireless connection between the UE 104 and the network 100, in particular the UE 104 and the Access and Mobility Management Function (AMF) 112. The RAN 106 acts as the bridge between the user plane 102 and the control plane 101, facilitating the establishment of communication sessions. As data travels through the RAN 106, it encounters the User Data Function (UDF) 108, which plays a pivotal role in processing and optimizing user data. The UDF 108 is responsible for tasks such as traffic optimization, content caching, and data transformation, enhancing the efficiency of data delivery.

The UDF 108 provides the data to the Data Network (DN) 110, which could represent the broader internet or a specific network service. The DN 110 processes and delivers the user data to its intended destination, completing the journey initiated by the UE 104. The collaborative operation of the user plane 102, UE 104, RAN 106, UDF 108, and DN 110 ensures that data is transmitted reliably and efficiently, meeting the high-performance expectations of 5G networks. As those skilled in the art readily appreciate, the separation of user plane 102 and control plane 101 allows for flexible network configurations and optimizations, contributing to the enhanced capabilities of the 5G ecosystem.

As noted above, when the UE 104 initiates a communication within the 5G network 100, the AMF 112 coordinates the interaction. For example, when the UE 104 initiates communication or moves within the 5G network 100, it sends signaling messages to the AMF 112. The AMF 112 is responsible for tasks such as authentication, authorization, and mobility management. Upon receiving the signaling messages from the UE 104, the AMF 112 validates the user's identity, checks for necessary permissions, and establishes the necessary context for the session. The AMF 112 coordinates with other network functions, such as the Session Management Function (SMF) 114 and the User Plane Function (UPF) 116, to ensure the seamless setup and management of communication sessions. The interaction with the control plane 101 enables the UE 104 to access network services, adhere to established policies, and maintain continuous connectivity while benefiting from the advanced capabilities and optimizations offered by the 5G network architecture.

The control plane 101 includes example components, nodes, or NFs. As illustrated, the control plane 101 includes the AMF 112, the SMF 114, the UPF 116, an Authentication Server Function (AUSF) 118, an Authentication and Authorization Function (AAF) 120, Service Communications Proxy (SCP) 122, a Network Slice Selection Function (NSSF) 124, Network Exposure Function (NEF) 126, a Network Repository Function or NF Repository Function (NRF) 128, a Packet Core Function (PCF) 130, a Unified Data Management (UDM) 132, an Application Function (AF) 134, and a Security Edge Protection Proxy (SEPP) 136. The selection of NFs 112-136 depicted in the 5G network 100 is exemplary, and some of the NFs 112-136 may be excluded, or other NFs added to the collection, without departing from the scope of this disclosure. The various NFs 112-136 execute various operations to provide communication services to UEs, such as the UE 104, that connects to the 5G network 100. A network node or NF that provides service is referred to herein as a NF producer, while a network node or NF that consumes services is referred herein to as a NF consumer. A network function can be both a NF producer and a NF consumer depending on whether it is consuming or providing service.

The NFs 112-136 of the 5G network 100 exchange various communications in the course of providing network services. The communications may include messaging to establish or end secured communication channels, such as transport layer security (TLS) handshakes, as well as service-based interface (SBI) communications. As used herein, SBI is the term given to the application programming interface (API) based communication that can take place between two NFs within the 5G SBA. A given NF can utilize an API call over the SBI to invoke a particular service or service operation. Communications between NFs 112-136 may be performed over network links and communication channels of the 5G network 100 that are not explicitly depicted in FIG. 1.

When the UE 104 initiates communication within the 5G network 100, various network functions often operate in pairs, where one NF acts as the producer (“the NF producer”), generating or providing specific services or information, and the other NF acts as the consumer (the “NF consumer”), utilizing or consuming the produced services or information to complete service requests. For instance, consider the interaction between the SMF 114 and the Packet Core Function (PCF) 130. The SMF 114, as the NF consumer, initiates service requests related to session establishment, modification, or termination for UE sessions, such as for the UE 104. The SMF 114 communicates these requests to the PCF 130, acting as the NF producer, which performs functions related to session management, Quality of Service (QoS) enforcement, and access control. The PCF 130 processes the requests from the SMF 114, enforces QoS policies, manages session establishment and modification, and ensures appropriate access control based on network policies and conditions. Through this producer-consumer interaction, the SMF 114 and PCF 130 collaborate to deliver efficient and reliable service within the 5G network architecture.

As those skilled in the art readily appreciate, various NFs may act as NF producers and NF consumers. For example, a NF producer may be or include the PCF 130, the SMF 114, a unified data repository (UDR) (not shown), a charging function (CHF), Binding Support Function (BSF) (not shown) or a Network Data Analytic Function (NWDAF) (not shown). depending on the operation and the service request. A NF consumer may be or include the UE 104, a service capability function (SCF) (not shown), the SCP 122, the SMF 114, the AMF 112, the NEF 126, a security edge protection proxy (SEPP) 136, the AF 134, the UDR, or a charging function (CHF), depending on the operation and the service request.

As noted above, the 5G network 100 includes the SEPP 136. The SEPP 136 plays a crucial role in enhancing the security framework of the 5G network 100. For example, the SEPP 136 may act as a gateway between the 5G core network 100 and external networks, such as a visitor network, or service providers, thereby ensuring that all data exchanges are secure and compliant with the latest security protocols. It protects against unauthorized access and potential threats by encrypting and decrypting signaling messages, thereby safeguarding the integrity and confidentiality of communications. By monitoring and filtering traffic at the network edge, the SEPP 136 also helps in detecting and mitigating various cyber threats, ensuring robust protection for the 5G network's 100 expansive and dynamic infrastructure.

The SEPP 136 also plays an integral role in the security architecture of the 5G network 100 by interacting with other network functions to validate access tokens, such as OAuth tokens, for roaming or visitor devices. In some embodiments, when a visitor device roams into a new network, such as the 5G network 100, the SEPP 136 forwards the service request to the AAF 120 or similar network function responsible for token validation. The AAF 120 verifies the legitimacy and validity of the token, checking for factors like expiration and scope of access. Once the token is authenticated, the AAF 120 communicates the result back to the SEPP 136, which then ensures that only authorized devices gain access to the 5G network's 100 services. This collaborative process helps maintain stringent security standards and enables secure, seamless connectivity for roaming devices within the 5G network 100.

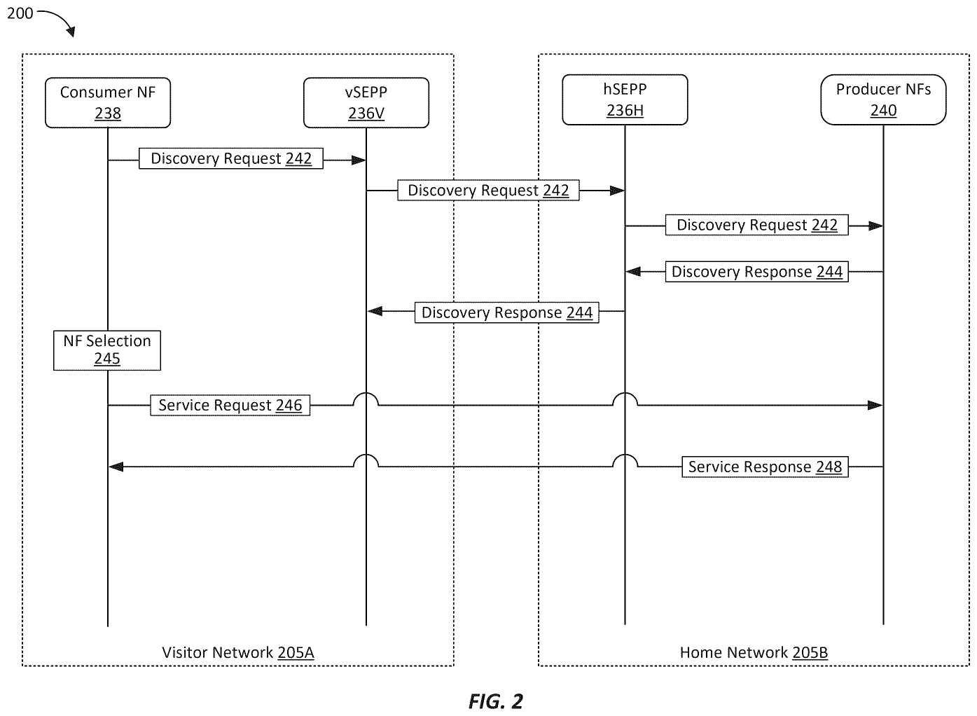

Referring now to FIG. 2, an example operational flow 200 of a visitor network 205A requesting services from a home network 205B is illustrated, according to an embodiment herein. Specifically, the operational flow 200 illustrates a visitor network 205A including a visitor consumer NF 238 and a visitor SEPP (vSEPP) 236V. The visitor consumer NF 238 may be or include any of the components described with respect to the 5G network 100. For example, the visitor consumer NF 238 may be an AMF, such as the AMF 112, an SMF, such as the SMF 114, or the like.

In the illustrated example, the home network 205B may be a Home Public Land Mobile Network (PLMN), while the visitor network 205A may be a visiting PLMN. A PLMN is a mobile network operated by a specific carrier, typically within a defined geographic area or country. When a user travels outside their home PLMN's coverage area and enters the territory of another PLMN, they connect to a new PLMN to continue receiving mobile services. Since the home and visitor networks 205A/B are operated by different carriers and are located in different regions or countries, they represent distinct domains, each with its own set of network functions, policies, and security protocols. These differences necessitate secure and controlled interactions between the two networks, ensuring that service continuity is maintained for the user while respecting the operational boundaries and security requirements of each PLMN.

While inter-domain routing scenarios described herein focus on routing between home and visitor networks, it should be appreciated that the discussed routing scenarios and examples are equally applicable to other inter-domain routing scenarios. For example, a user might roam between different PLMNs operated by different carriers when traveling internationally, requiring coordination between these distinct networks. Additionally, roaming can occur between a PLMN and a Non-Public Network (NPN), such as a private 5G network deployed within an enterprise or industrial setting. In this case, specialized procedures are needed to ensure that the user's device can securely access services while transitioning between the public network and the private environment. Furthermore, even within the same PLMN, different regional organizations or administrative units might manage their own network segments, each with unique policies or configurations. When a user moves between these regions, roaming procedures are invoked to maintain service without disruption, effectively treating these regional segments as separate domains. In all these scenarios, the techniques and systems disclosed herein may be implemented to ensure that users experience consistent and secure connectivity, regardless of the underlying network domain they are accessing.

In the illustrated example, a client device associated with the visitor network 205A may roam into the home network 205B. When the visitor network 205A seeks to utilize services from the home network 205B, it initiates the process by transmitting a discovery request 242. This request is routed through the vSEPP 236V of the visitor network, which ensures the security and integrity of the communication. The discovery request 242 is then directed to the hSEPP 236H of the home network 205B. Upon receiving the discovery request 242, the home network 205B processes the request 242 and determines the appropriate network functions and services required to fulfill the request. In particular, the hSEPP 236H may route the discovery request 242 to one or more producer NFs 240 for processing the request 242.

Responsive to the discovery request 242, the home network 205B generates a discovery response 244, which contains the necessary information for service provisioning. In particular, the producer NFs 240 may include a home Network Repository Function (hNRF) 128 that generates the discovery response 244. The discovery response 244 may include crucial information that enables the visitor network 205A to proceed with service utilization. As such, the discovery response 244 may contain identifiers for the relevant network functions within the home network 205B that are available to handle the service request. For example, the discovery response 244 may include information about the type of network functions, their capabilities, and the specific services they support. Additionally, the discovery response 244 may include routing information, endpoint addresses, and necessary authorization credentials required for secure and efficient communication between the visitor network and the home network's functions. By providing this information, the home network 205B ensures that the visitor network 205A can effectively interact with the appropriate network functions to fulfill its service needs.

Once generated, the discovery response 244 may be securely routed back to the visitor network 205A via an established communication path between the hSEPP 236H and the vSEPP 236V. Upon receiving the discovery response 244, the visitor network 205A processes the information, including the details about the available network functions within the home network 205B. Based on this information, the visitor network 205A may perform NF selection 245, choosing the most appropriate NF within the home network 205B to handle its specific service requirements. Following the NF selection 245, the visitor network 205A may send a service request 246 directly to the chosen NF within the home network 205B. This service request 246 initiates the interaction needed to furnish the desired services, allowing the visitor network 205A to seamlessly utilize the resources of the home network 205B. As shown, this may include the home network 205B responding to the service request 246 with a service response 248, which may include a successful response and/or the requested services.

As noted above, sharing of NF topology information from the home network 205B with the visitor network 205A, and allowing the visitor network 205A to perform NF selection 245, presents several potential drawbacks. Firstly, exposing detailed NF topology to the visitor network 205A increases security risks, as it provides external entities with insights into the home network's 205B internal architecture, potentially making it more vulnerable to targeted attacks or unauthorized access. This level of transparency could also lead to unintended consequences, such as the visitor network 205A inadvertently selecting suboptimal or overloaded NFs, resulting in decreased performance or service degradation. Additionally, by relinquishing control over NF selection, the home network 205B may lose the ability to optimize resource allocation according to its internal policies and operational strategies, which could lead to inefficiencies and reduced quality of service for its users. Finally, the complexity of inter-network coordination increases when the visitor network 205A is involved in NF selection 245, potentially leading to interoperability issues or misconfigurations that disrupt seamless service delivery.

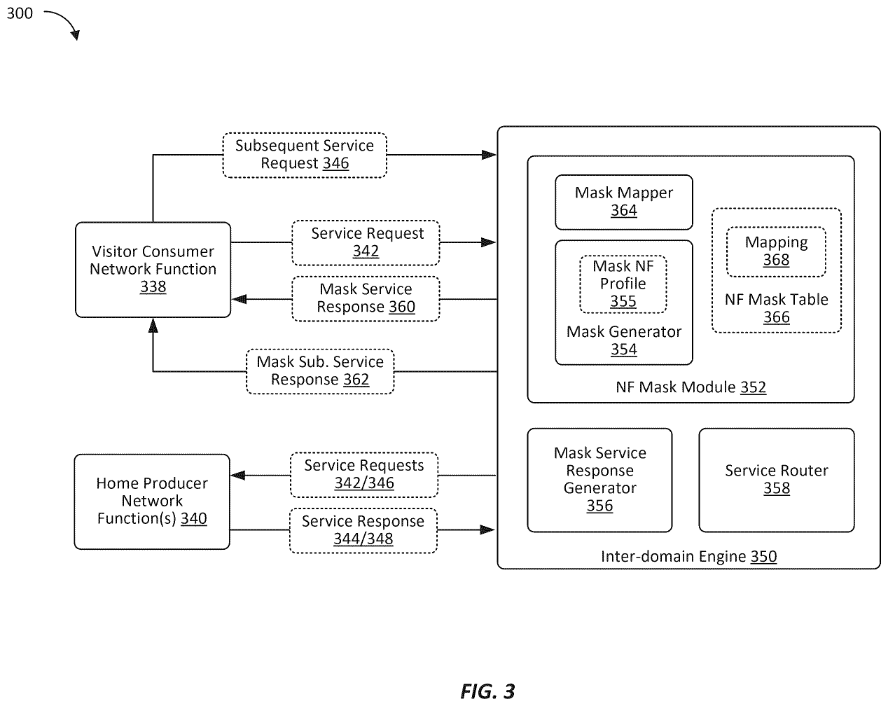

Accordingly, to facilitate seamless roaming and service management between different domains without disclosing sensitive NF topology information or relinquishing NF selection to a visitor network, an example inter-domain engine is provided herein. Referring now to FIG. 3, an operational environment 300 is illustrated in which an inter-domain engine 350 masks NF topology of a home network when exchanging communications with a visitor network, according to an embodiment herein. As shown, the inter-domain engine 350 may be in operational communication with a visitor consumer NF 338, which may be the same or similar to the visitor consumer NF 238, and a home producer NF 340 which may be the same or similar to the home producer NF 240.

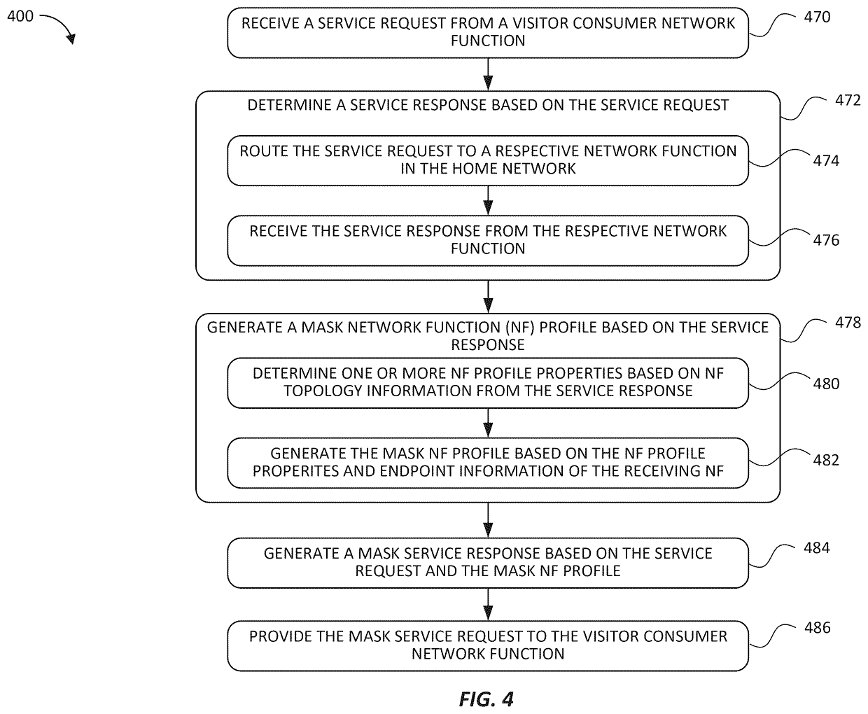

For ease of explanation, FIG. 3 is described in conjunction with FIG. 4, which provides an example inter-domain engine process, in particular a process 400 for providing the inter-domain engine 350 and one or more of its functions, according to an embodiment herein. In other words, FIG. 4 illustrates the process 400 for masking NF topology during inter-domain routing of requests or responses (e.g., communications), according to an embodiment herein. While FIG. 4 is described with relation to FIG. 3, it should be appreciated that components, elements, and steps from any other Figures described herein may be equally applicable.

As shown in FIG. 3, the inter-domain engine 350 may receive a service request 342 from the visitor consumer NF 338 (470). In some embodiments, the service request 342 may be or include a discovery request, such as the discovery request 242, in other embodiments, the service request 342 may be or include a request for services such as the request 246. The inter-domain engine 350 may be part of or in operational communication with a home network's hSEPP, such as part of the hSEPP 236H within the home network 205B. As such, when the hSEPP receives the service request 342, the service request 342 may also be routed to the inter-domain engine 350.

Responsive to receiving the service request 342, the inter-domain engine 350 may determine a service response based on the service request 342 (472). In particular, the inter-domain engine 350 may include a service router 358 that routes the service request 342 to a respective network function, such as one or more of the producer NFs 340 within the home network for servicing the service request 342 (474) and receive the service response 344 from the respective network function (476). For example, if the service request 342 is a discovery request, then service router 358 of the inter-domain engine 350, via the hSEPP, may route the service request 342 to the hNRF 128 for servicing the discovery request. Responsive to receiving the discovery request, the hNRF 128 may generate and send a discovery response to the hSEPP for routing back to the visiting NF consumer 338. In other scenarios, such as those described in greater detail below, the service router 358 may route the service request 342 to the producer NF 340, which may include an UDM, such as the UDM 132, a PCF, such as the PCF 130, an UDR, an AUSF, such as the AUSF 118, and the like for furnishing the service request 342.

Once the inter-domain engine 350 receives the service response 344 from the home producer NF 340, such as the hNRF 128 or the PCF 130, the inter-domain engine 350 may mask the service response 344 instead of forwarding the service response 344 directly onto the visitor network to prevent sharing of any NF topology information. To mask the service response 344, the inter-domain engine 350 may generate a mask NF profile 355 based on the service response 344 (478). In particular, the inter-domain engine 350 may include an NF masking module 352 that contains a mask generator 354 that generates the mask NF profile 355 based on the service request 342. As will be described in greater detail below, the mask NF profile 355 may be used as a dummy NF profile to the service request 342 to prevent sharing of the NF topology of the home network with the visiting consumer NF 338. Additionally, the mask profile 355 allows NF selection to be performed by the home network instead of by the visitor network.

To generate the mask NF profile 355, the mask generator 354 may determine NF profile properties based on NF topology information in the service response 344 (480). As those skilled in the art readily appreciate, the service response 344, such as a discovery response to a roaming discovery request, typically includes a set of technical details that enables the visiting consumer NF 338 to interact effectively with the home network's NFs. For example, discovery responses generally include NF profiles, which provide comprehensive descriptions of the available NFs within the home network. These profiles include critical information such as the NF type (e.g., AMF, SMF), the specific services each NF supports, and their associated capabilities. Alongside the NF profiles, the discovery response includes NF properties, which detail the operational parameters and configurations of each NF. This might involve information on load thresholds, supported protocols, and geographic service areas. Additionally, endpoint information is provided to facilitate communication with the selected NFs, which includes the communication scheme (e.g., HTTP, HTTPS), the fully qualified domain name (FQDN) of the NF, port numbers for network access, and API prefixes that define the specific endpoints for service interaction.

Based on the NF profile properties in the service response 344, the mask generator 354 may generate the mask NF profile 355. For example, if the service response 344 includes multiple NF profiles, each providing operational parameters, configurations, and endpoint information for each NF profile, the mask generator 354 may generate the mask NF profile to provide the same parameters, configurations, and endpoint information, except with dummy or mask values inputted. For example, if an NF profile provided as part of the service response 344 includes endpoint information for a respective NF, the mask generator 354 may generate the mask NF profile 355 to include endpoint information corresponding to the hSEPP. That is, instead of providing the communication scheme, FQDN, port numbers for the network access, and API prefixes (e.g., endpoint information) for the NF identified in the service response 344, the mask NF profile 355 will include each of these respective properties with information of the hSEPP. Accordingly, because the mask NF profile 355 includes the endpoint information corresponding to the hSEPP, when the visitor consumer NF 338 performs, what it believes to be NF selection, it will end up routing subsequent service requests to the hSEPP based on the endpoint information provided in the mask NF profile 355.

Once the mask NF profile 355 is generated, the inter-domain engine 350 may generate a mask service response (474). The inter-domain engine 350 may include a mask service response generator 356 that may generate a mask service response 360. The mask service response 360 may be based on the service response 344 and the mask NF profile 355. Once generated, the inter-domain engine 350 may provide the mask service response 306 to the hSEPP for transmission back to the visitor consumer NF 338 (486).

In addition to generating and sending the mask service response 360, the inter-domain engine 350 may also generate a mapping 368 of the mask NF profile 355 to the service response 344, and in some cases, the service request 342 as well. In particular, the NF mask module 352 may generate the mapping 368 and store or cache the mapping 368 in a NF mask table 366. The mapping 368 may associate the NF profile 355 with the service response 344 such that if the visitor consumer NF 338 sends subsequent service requests to the home network, the inter-domain engine 350 can identify the service response 344 to which the NF profile 355 corresponds. As will be described below, because the home network responds to the service request 342 using the mask NF profile 355, any subsequent request/response from the visitor consumer NF 338 may be based on the mask NF profile 355. Since the mask NF profile 355 includes dummy or not real properties, the inter-domain engine 350 maps the subsequent response/request to the actual NF topology information associated with furnishing services for the visitor consumer NF 338.

In some embodiments, the mapping 368 may include an expiry date or validity period during which the service response 344 from the home producer NF 340 is valid. As those skilled in the art readily appreciate, service responses 344 from a home network, like a discovery response, are typically time-sensitive and may only be valid for a limited period. This limitation ensures that the information provided remains accurate and relevant within a rapidly changing network environment. After the validity period expires, the service response 344 may no longer be reliable, necessitating a fresh request to obtain up-to-date data. This approach helps maintain network efficiency and integrity by preventing the use of outdated information. Accordingly, the mapping 368 may include the validity period during which the service response 344 is valid.

After receiving the mask service response 360, the visitor consumer NF 338 may transmit a subsequent service request 346 to the home network. As noted above, the inter-domain engine 350 may be part of the hSEPP and as such, the subsequent service request 346 may be routed to the inter-domain engine 350. In an example, the subsequent service request 346 may be an initial service request from the visitor consumer NF 338 responsive to receiving the mask service response 360. As such, the service request 346 may include information based on the mask NF profile 355, such as a 3gpp-sbi-target-apiRoot header containing information associated with the masked NF profile 355 (e.g., masked scheme, masked authority (e.g., fqdn and port), and masked apiPrefix).

The NF mask module 352 may map the subsequent service request 346 to the previously sent mask service response 360. In particular, the inter-domain engine 350 may include a mask mapper 364 which may map the subsequent service request 346 to the mask NF profile 355 stored or cached in the NF mask table 366. For example, since the masked service response 360 contains the masked NF profile 355 along with one or more NF services as applicable/received from the home producer NF 340, and each NF service within the masked NF profile 355 contains a respective, scheme, authority (i.e., fqdn and port) and apiPrefix, the combination of the NF service information and the mask information of the mask NF profile 355 can be used to map the subsequent service request 346 to the original service response 344.

Based on the mapping of the subsequent service request 346 to the mask NF profile 355, the inter-domain engine 350 may determine the corresponding service response 344. Since the service response 344 includes information such as NF profiles for NFs that can service the service request 342/346, the inter-domain engine 350 may identify the NFs within the home network for handling the subsequent service request 346.

As noted above, because the visitor network received the mask service response 360 instead of the service response 344, the visitor network is unable to perform NF selection of a NF within the home network for furnishing services. Instead, the visitor network may “think” or perform a dummy NF selection in which it selects the hSEPP (unbeknownst to the visitor network) for servicing requests based on the mask NF profile 355. Accordingly, responsive to receiving the subsequent service request 346 and mapping it to the service response 344 received from the home producer NF 340, the inter-domain engine 350 causes for NF selection to be performed within the home network.

In some embodiments, the inter-domain engine 350 or the hSEPP may perform NF selection based on the service response 344. That is, the inter-domain engine 350 may select a target producer NF 340 within the home network for furnishing the subsequent service request 326. To select the target producer NF 340, the inter-domain engine 350 may check the service response 344 or respective discovery response generated by the home NRF at the outset of session initiation with the visitor consumer NF 338. Based on the service response 344 (or discovery response), the inter-domain engine 350 may select a NF within the home network for furnishing the subsequent service request 346. As can be appreciated, the NF selection process may include selecting an NF from the available NFs identified in the service response 344 based on criteria such as load balancing, network topology, and functional capabilities. The inter-domain engine 350 may match the subsequent service request 346 to the most suitable NF of the available NFs in the home network that meets the required performance and operational criteria.

In embodiments where the inter-domain engine 350 performs NF selection, the service router 358 may route the subsequent service request 346 to a selected home producer NF 340 or to a home producer NF 340, such as the SCP, for routing to the selected NF. In some embodiments, the inter-domain engine 350 may generate a target NF header for the subsequent service request 346 that indicates the selected producer NF for handling the subsequent service request 346. For example, the inter-domain engine 350 may modify or generate a 3gpp-sbi-target-apiRoot header for the subsequent service request 346 that indicates the selected producer NF. In some cases, the inter-domain engine 350 may also generate a custom header including alternative producer NFs information. That is, the inter-domain engine 350 may modify the subsequent service request 346 to include a target NF header that indicates the selected producer NF and a custom header that indicates alternative producer NFs in the event that the selected producer NF is unavailable or unable to service the request.

As noted above, depending on the routing protocols and procedures within the home network, the service router 358 may route the subsequent service request 346 to either the selected producer NF 340 or to the home SCP. If the service router 358 sends the subsequent service request 346 to the home SCP, the home SCP may route the subsequent service request 346 to the selected producer NF 340 based on the modified header generated by the inter-domain engine 350.

In other embodiments, instead of performing NF selection, the inter-domain engine 350 may route the subsequent service request 346 to a respective home producer NF 340, such as the SCP, for NF selection. In such cases, the inter-domain engine 350 may generate a custom header for the subsequent service request 346 that includes the NF topology information as provided in the original service response 344 (or discovery response). That is, the inter-domain engine 350 may modify the subsequent service request 346 to include a custom header including relevant information for available NFs within the home network for furnishing the subsequent service request 346. By including the NF topology information in a custom header of the subsequent service request 346, the inter-domain engine 350 can provide the relevant information for available NFs to the home producer NF 340 for NF selection. Responsive to receiving the modified subsequent service request 346, the respective home producer NF 340, such as the home SCP may perform NF selection and route the subsequent service request 346 to the selected producer NF.

Regardless of how the subsequent service request 346 is routed to a selected producer NF 340, the selected producer NF may generate a service response 348. The service response 348 may indicate that the service request 346 is successfully furnished or that the home network is unable to service request 346. The service response 348 may be routed to the inter-domain engine 350 via the hSEPP, where the inter-domain engine 350 may mask the service response 348 before routing it to the visitor consumer NF 338. The NF mask module 352, in coordination with the mask service response generator 356, may mask the service response 348 based on the mask NF profile 355. For example, the NF mask module 352 may identify the mask NF profile 355 associated with the service response 348 from the NF mask table 366 and then the mask service response generator 356 may generate a mask subsequent service response 362. In some embodiments, to generate the mask subsequent service response 362, the mask service response generator 356 may modify a header (e.g., location, custom, HTTP header) of the service response 348 based on the mask NF profile 355 (e.g., to include the endpoint information of the hSEPP). Additionally, the mask service response generator 356 may mask or obscure binding header information in the service response 348.

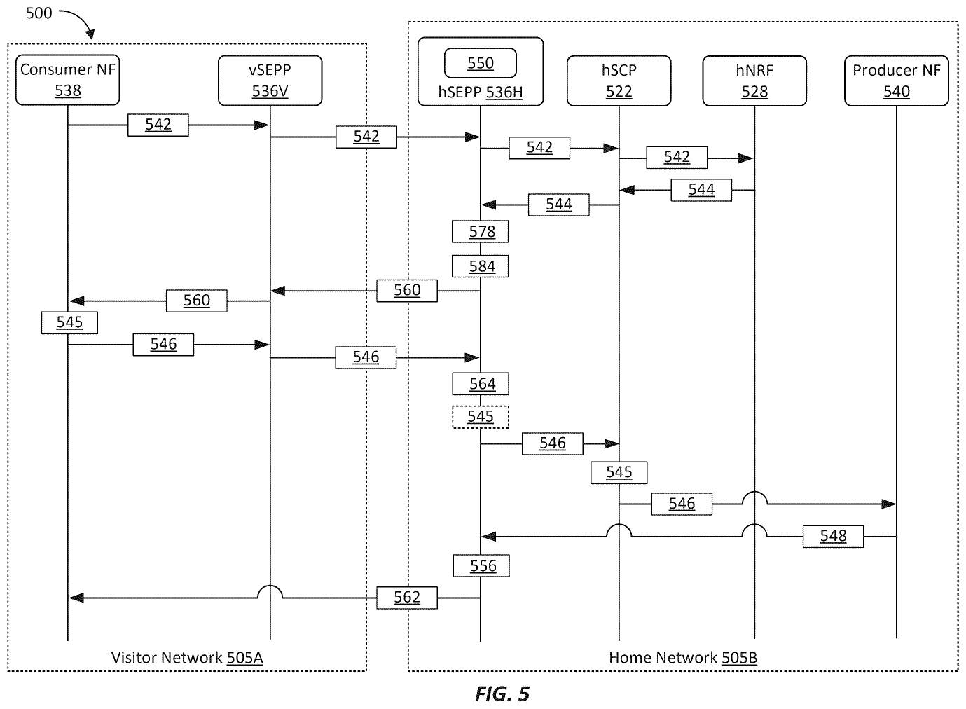

Referring now to FIG. 5, an example operational flow 500 for providing an inter-domain engine 550 is illustrated, according to an embodiment herein. The inter-domain engine 550 may be the same or similar to the inter-domain engine 350, and as such may mask NF topology information during communication exchanges with a visitor network 505A. As illustrated, the operational flow 500 is illustrated between the visitor network 505A and a home network 505B, which may be the same or similar to the visitor network 205A and the home network 205B, respectively. As such, the visitor network 505A may include a visitor consumer NF 538 and a visitor SEPP (vSEPP) 536V, which may be the same or similar to the visitor consumer NF 238 and the vSEPP 236V, respectively.

The visitor consumer NF 538 may correspond to a client device that is requesting services within the home network 505B. As such, the consumer NF 538 may submit a discovery request 542 to the home network 505B, such as via the vSEPP 536V. The vSEPP 536V may transmit the discovery request 542 to a hSEPP 536H of the home network 505B. As illustrated, the hSEPP 536H may include an inter-domain engine 550. As such, responsive to receiving the discovery request 542, the inter-domain engine 550 may determine a respective discovery response 544 for the request 542. To determine the discovery response 544, the inter-domain engine 550 may route the discovery request 542 to a home NRF (hNRF) 528 via a home SCP (hSCP) 522. Responsive to receiving the discovery request 542, the hNRF 528 may generate and send the discovery response 544.

The hNRF 528 may intend to route the discovery response 544 to the visitor network 505A responsive to receiving the discovery request 542, however, the inter-domain engine 550 may intercept the discovery response 544 and mask it before it is sent to the visitor network 505A. As described above, masking the discovery response 544 may include generating a mask NF profile, such as the mask NF profile 355, based on the discovery response 544 (578). The mask NF profile may be or include a NF type corresponding to available NFs identified in the discovery response 544. The mask NF profile may also include NF properties that are similar to the available NFs, such as parameters and configurations, as well as endpoint information. However, as described above, the mask NF profile may provide dummy or mask information for the corresponding properties, such as using the endpoint information of the hSEPP 536H for the endpoint information.

Based on the mask NF profile, the inter-domain engine 550 may generate a mask service response 560 based on the service response 544 (584), such as the mask service response 360. In an example, the mask service response 360 may include the NF mask profile that includes the endpoint information for the hSEPP 536H. Once generated, the hSEPP 536H may provide the mask service response 360 to the visitor network 505A, such as to the vSEPP 536V.

Responsive to receiving the mask service response 360 the consumer NF 538 or another NF such as the SCP within the visitor network 505A may perform an NF selection. However, as noted above, because the mask service response 360 does not include information for actual NFs within the home network 505B, a selected NF by the visitor network 505A may be or include the hSEPP 536H. Again, the visitor network 505A may not know that it is selecting the hSEPP 536G since it performed NF selection based on the mask NF profile.

Subsequent to performing the NF selection, the vSEPP 536V may forward an initial service request 546 from the selecting NF (e.g., consumer NF 538) to request services from the home network 505B. The service request 546 may be received by the hSEPP 536G and routed to the inter-domain engine 550. Responsive to receiving the service request 546, the inter-domain engine 550 may map the service request 546 to the mask NF profile and identify the associated discovery response 544 (564). As described above, based on the discovery response 544, the inter-domain engine 550 may either perform NF selection 545 itself or route the service request 546 to the hSCP 522 for NF selection 545.

Once NF selection is performed, either by the hSEPP 536H or by the hSCP 522, the service request 546 may be transmitted to a respective producer NF 540. The producer NF 540 may be a NF that is available and able to furnish the service request 546. For example, the producer NF 540 may be or include the AMF 112, SMF 114, PCF 130, UDM 132, and the like. Responsive to receiving the service request 546, the producer NF 540 may generate and transmit a service response 548 and/or furnish the requested services. As illustrated, the service response 548 may be routed via the hSEPP 536H to the visitor network 505A. As such, the hSEPP 536G may generate a mask service response 562 (556) based on the service response 548 before sending the mask service response 562 to the visitor network 505A.

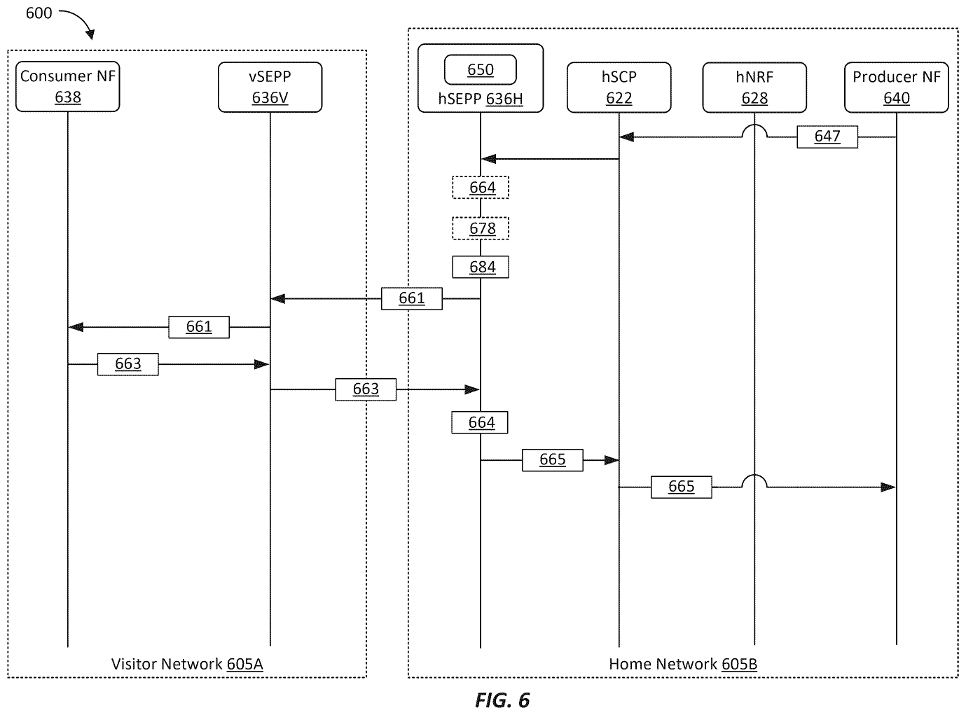

Referring now to FIG. 6, another example operational flow 600 for providing an inter-domain engine 650 is illustrated, according to an embodiment herein. The inter-domain engine 650 may be the same or similar to the inter-domain engine 350 and/or 550, and as such may mask communication exchanges between a visitor network 605A and a home network 605B. Similar to the operational flow 500, a visitor consumer NF 638 may correspond to a client device that is requesting services within the home network 605B, which may be the same or similar to the home network 505B. As such, the visitor consumer NF 638 may submit a service request 642 to the home network 605B, such as via a vSEPP 636V from the visitor network 605A, which may be the same or similar to the visitor network 505A.

In the illustrated flow 600, the inter-domain engine 650 may mask a communication generated by the home network 605B before transmitting it to the visitor network 605A. Example communications that may be masked by the inter-domain engine 650 may include notifications and other service requests generated by the home network 605B and sent to the visitor network 605A. As shown, a producer NF 640 in the home network 605B may generate and send a communication 647, which may be a notification or service request, to the visitor consumer NF 638. The communication 647 may be routed to the visitor network 605A via the hSEPP 636H. As such, once the hSEPP 636H receives the communication 647, the communication 647 may be routed to the inter-domain engine 650.

Once the inter-domain engine 650 receives the communication 647, the inter-domain engine 650 may map the communication 647 to a respective NF mask profile that is stored or cached within a NF mask table (664). If the producer NF 640 is exchanging the communication 647 with the visitor network 605A, then it is likely that a session is already established between the visitor consumer NF 638 and the producer NF 640. As such, a respective mask NF profile may be stored and cached by the inter-domain engine 650 for the on-going session. However, if the scenario arises where a respective mask NF profile has not been previously stored/cached, the inter-domain engine 650 may generate a mask NF profile as described above (678). For example, if the communication 647 originates from the home network 605B, the inter-domain engine 650 may generate a mask NF profile to mask the originating producer NF 640.

Once a mask NF profile is determined (either mapped or generated), the inter-domain engine 650 may generate a mask communication 661 (684) based on the communication 647 and the mask NF profile. As described above, the mask communication 661 may mask NF topology information present in the communication 647, such as by replacing endpoint information in the communication 647 that is associated with the producer NF 640 to end point information of the hSEPP 636H. The mask communication 661 may be transmitted to the visitor network 605A and routed to a respective consumer NF 638 via the vSEPP 636V.

Responsive to receiving the mask communication 661, the consumer NF 638 may generate a response communication 663. Since the mask communication 661 includes the endpoint information of the hSEPP 636H, the response communication 663 may be routed to the hSEPP 636H, instead of directly to the producer NF 640. Responsive to receiving the response communication 663, the inter-domain engine 650 may map the response communication 663 to the mask NF profile and identify the corresponding communication 647 (664). Once the communication 647 is identified, the inter-domain engine 650 may modify the response communication 663 to include the appropriate or correct information of the producer NF 640 as indicated by the communication 647. That is, the inter-domain engine 650 may generate a modified communication 665 based on the response communication 663 that includes the correct NF information for routing purposes. The hSEPP 636H may then route the modified communication 665, via a hSCP 622, to the producer NF 640.

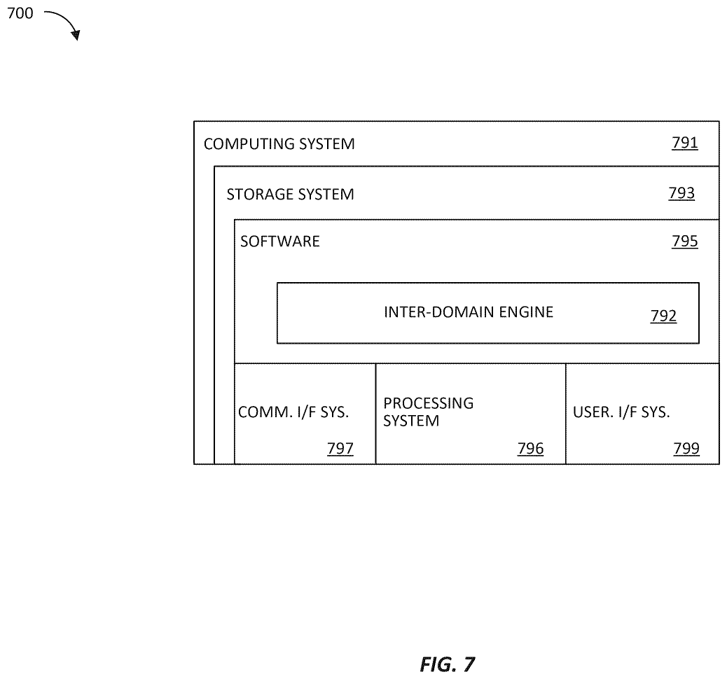

Referring now to FIG. 7, is a diagram of a system 700 configured to implement an inter-domain engine, according to an embodiment herein. The system 700 may be an example of an apparatus including a computing apparatus 791 that is representative of any system or collection of systems in which the various processes, systems, programs, services, and scenarios disclosed herein may be implemented. For example, computing apparatus 791 may be an example inter-domain engine, such as the inter-domain engine 350/550/650, a producer NF or consumer NF, such as any of the visitor consumer NFs or home producer NFs discussed herein, a SEPP, such as the vSEPPs and hSEPPS discussed herein, or any of the subcomponents depicted in the 5G network, 100, operational flows 200, 500 or 600, or the operational environment 300 of FIGS. 1-6, respectively. Examples of computing apparatus 791 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 791 may be implemented as a single apparatus, system, or device or may be implemented in a distributed manner as multiple apparatuses, systems, or devices. Computing apparatus 791 may include, but is not limited to, processing system 796, storage system 793, software 795, communication interface system 797, and user interface system 799. Processing system 796 may be operatively coupled with storage system 793, communication interface system 797, and user interface system 799.

Processing system 796 may load and execute software 795 from storage system 793. Software 795 may include an inter-domain engine 792, which may be representative of any of the operations for providing an inter-domain engine or any of its related functions, as discussed with respect to the preceding figures. When executed by processing system 796, software 795 may direct processing system 796 to operate as described herein for at least the various processes, such as the process 400 or any of the operational flows 500-600, operational scenarios, and sequences discussed in the foregoing implementations. Computing apparatus 791 may optionally include additional devices, features, or functionality not discussed for purposes of brevity.

In some embodiments, processing system 796 may comprise a micro-processor and other circuitry that retrieves and executes software 795 from storage system 793. Processing system 796 may be implemented within a single processing device but may also be distributed across multiple processing devices or sub-systems that cooperate in executing program instructions. Examples of processing system 796 may include general purpose central processing units, graphical processing units, application specific processors, and logic devices, as well as any other type of processing device, combinations, or variations thereof.

Storage system 793 may comprise any memory device or computer-readable storage medium readable by processing system 796 and capable of storing software 795. Storage system 793 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 793 may also include computer readable communication media over which at least some of software 795 may be communicated internally or externally. Storage system 793 may be implemented as a single storage device but may also be implemented across multiple storage devices or sub-systems co-located or distributed relative to each other. Storage system 793 may comprise additional elements, such as a controller, capable of communicating with processing system 796 or possibly other systems.

Software 795 (including the inter-domain engine 792 among other functions) may be implemented in program instructions that may, when executed by processing system 796, direct processing system 796 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 795 may include additional processes, programs, or components, such as operating system software, virtualization software, or other application software. Software 795 may also comprise firmware or some other form of machine-readable processing instructions executable by processing system 796.

In general, software 795 may, when loaded into processing system 796 and executed, transform a suitable apparatus, system, or device (of which computing apparatus 791 is representative) overall from a general-purpose computing system into a special-purpose computing system as described herein. Indeed, encoding software 795 on storage system 793 may transform the physical structure of storage system 793. The specific transformation of the physical structure may depend on various factors in different implementations of this description. Examples of such factors may include, but are not limited to, the technology used to implement the storage media of storage system 793 and whether the computer-storage media are characterized as primary or secondary storage, as well as other factors.

For example, if the computer-readable storage medium is implemented as semiconductor-based memory, software 795 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 797 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 791 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, aspects of the present invention may take the form of a computer program product embodied in one or more memory devices or computer readable medium(s) having computer readable program code embodied thereon.

The foregoing examples and descriptions are described herein in the context of systems and methods for providing an inter-domain engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; processor-executable instructions stored on the computer-readable storage medium; and one or more processors coupled to the computer-readable storage medium and configured to execute the processor-executable instructions to operate a first network function (NF) within a first network, wherein the first NF comprises an inter-domain engine, such that the processor-executable instructions, when executed by the one or more processors, direct the computing apparatus, to at least: determine a first service request from a visitor consumer NF, wherein the first NF is in a first network and the visitor consumer NF is in a second network; determine a service response based on the first service request, wherein the service response comprises NF topology information for furnishing the service request within the first network; generate, by the inter-domain engine, a mask NF profile based on the service response; generate, by the inter-domain engine, a mask service response based on the mask NF profile and the first service request; and transmit the mask service response to the visitor consumer NF.

Example 2 is the computing apparatus of any previous or subsequent Example, wherein the processor-executable instructions, when executed by the one or more processors, further direct the computing apparatus to: generate, by the inter-domain engine, a mask mapping of the mask NF profile to the service response; determine, by the inter-domain engine, a validity period for the service response; and store, by the inter-domain engine, the mask mapping and the service response for the validity period of the service response.

Example 3 is the computing apparatus of any previous or subsequent Example, wherein the processor-executable instructions to generate, by the inter-domain engine, the mask NF profile based on the service response, when executed by the one or more processors, further direct the computing apparatus to: determine, by the inter-domain engine, one or more NF profile properties of the NF topology information from the service response; and generate, by the inter-domain engine, the mask NF profile based on the one or more NF profile properties and endpoint information of the first NF.

Example 4 is the computing apparatus of any previous or subsequent Example, wherein the first service request comprises a discovery request and the service response comprises a discovery response, and the processor-executable instructions to determine the service response based on the first service request, when executed by the one or more processors, further direct the computing apparatus to: forward the discovery request received from the visitor consumer NF to a Home Repository Function (NRF) in the first network; and receive, from the NRF, the discovery response from the NRF, wherein the NRF determines the NF topology information for servicing the discovery request.

Example 5 is the computing apparatus of any previous or subsequent Example, wherein the processor-executable instructions, when executed by the one or more processors, further direct the computing apparatus to: receive a second service request from the visitor consumer NF; determine, by the inter-domain engine, the mask NF profile based on the second service request; determine, by the inter-domain engine, the service response associated with the second service request based on the mask NF profile; and route the second service request to one or more producer NFs in the first network based on the service response, wherein the one or more producer NFs furnish the second service request responsive to receiving the second service request.

Example 6 is the computing apparatus of any previous or subsequent Example, wherein the processor-executable instructions, when executed by the one or more processors, further direct the computing apparatus to: receive a second service request from the visitor consumer NF; map, by the inter-domain engine, the second service request to the mask NF profile; determine, by the inter-domain engine, the NF topology information of the service response associated with the mask NF profile; and transmit, by the first NF, the second service request and the NF topology information to a second NF within the first network, wherein the second NF performs one of: NF selection; or routing of the second service request based on the NF topology information.

Example 7 is the computing apparatus of any previous or subsequent Example, wherein the first NF comprises a Security Edge Protection Proxy (SEPP) within the first network.

Example 8 is a method comprising: determining, by a first network function (NF), a first service request from a visitor consumer NF, wherein the first NF is in a first network and the visitor consumer NF is in a second network; determining, by the first NF, a service response based on the first service request, wherein the service response comprises NF topology information for furnishing the service request within the first network; generating, by an inter-domain engine of the first NF, a mask NF profile based on the service response; generating, by the inter-domain engine, a mask service response based on the mask NF profile and the first service request; and transmitting, by the first NF, the mask service response to the visitor consumer NF.

Example 9 is the method of any previous or subsequent Example, wherein the method further comprises: receiving, by the first NF, a second service request from the visitor consumer NF; determining, by the inter-domain engine, the mask NF profile based on the second service request; determining, by the inter-domain engine, the service response associated with the second service request based on the mask NF profile; determining, by the inter-domain engine, a producer NF in the first network for furnishing the second service request based on the service response; and routing, by the first NF, the second service request to the producer NF, wherein the producer NF furnishes the second service request responsive to receiving the second service request.

Example 10 is the method of any previous or subsequent Example, wherein the method further comprises: receiving, by the first NF, a second service request from the visitor consumer NF; mapping, by the inter-domain engine, the second service request to the mask NF profile; determining, by the inter-domain engine, the NF topology information of the service response associated with the mask NF profile; and transmitting, by the first NF, the second service request and the NF topology information to a second NF within the first network, wherein the second NF performs one of: NF selection; or routing of the second service request based on the NF topology information.

Example 11 is the method of any previous or subsequent Example, wherein the method further comprises: generating, by the inter-domain engine, a mask mapping of the mask NF profile to the service response; and storing, by the inter-domain engine, the mask mapping and the service response.

Example 12 is the method of any previous or subsequent Example, wherein the mask NF profile comprises endpoint information for the first NF corresponding to the respective NF topology information in the service response.

Example 13 is the method of any previous or subsequent Example, wherein: the first service request comprises a discovery request; the service response comprises a discovery response; and determining, by the first NF, the service response based on the first service request further comprises: forwarding, by the first NF, the discovery request received from the visitor consumer NF to a Home Repository Function (NRF) in the first network; and receiving, from the NRF, the discovery response from the NRF, wherein the NRF determines the NF topology information for servicing the discovery request.

Example 14 is the method of any previous or subsequent Example, wherein the first network comprises a first Public Land Mobile Network (PLMN) and the second network comprises a second PLMN.

Example 15 is the method of any previous or subsequent Example, wherein the first NF comprises a Security Edge Protection Proxy (SEPP) within the first network.

Example 16 is a computer-readable storage medium comprising processor-executable instructions, wherein the processor-executable instructions, in part, operate a first network function (NF) within a first network such to cause one or more processors to: determine a first service request from a visitor consumer NF, wherein the visitor consumer NF is in a second network that is different than the first network; determine a service response based on the first service request, wherein the service response comprises NF topology information for furnishing the service request within the first network; generate, by an inter-domain engine, a mask NF profile based on the service response; generate, by the inter-domain engine, a mask service response based on the mask NF profile and the first service request; and transmit the mask service response to the visitor consumer NF.

Example 17 is the computer-readable storage medium of any previous or subsequent Example, wherein the processor-executable instructions to generate, by the inter-domain engine, the mask NF profile based on the service response cause the one or more processors to further execute processor-executable instructions stored in the computer-readable storage medium to: determine, by the inter-domain engine, an NF profile comprising one or more NF profile properties; and generate, by the inter-domain engine, the mask NF profile based on the one or more NF profile properties and endpoint information of the first NF, wherein the endpoint information of the first NF comprises at least one of: a scheme associated with the first NF; a Fully Qualified Domain Name (FQDN) associated with the first NF; a port associated with the first NF; or an Application Programming Interface (API) prefix associated with the first NF.

Example 18 is the computer-readable storage medium of any previous or subsequent Example, wherein the processor-executable instructions cause the one or more processors to further execute processor-executable instructions stored in the computer-readable storage medium to: receive a second service request from the visitor consumer NF; map, by the inter-domain engine, the second service request to the mask NF profile; determine, by the inter-domain engine, the service response associated with the second service request based on the mask NF profile; determine, by the inter-domain engine, a producer NF in the first network for furnishing the second service request based on the service response; and route, by the first NF, the second service request to the producer NF, wherein the producer NF furnishes the second service request responsive to receiving the second service request.

Example 19 is the computer-readable storage medium of any previous or subsequent Example, wherein the processor-executable instructions cause the one or more processors to further execute processor-executable instructions stored in the computer-readable storage medium to: receive a second service request from the visitor consumer NF; map, by the inter-domain engine, the second service request to the mask NF profile; determine, by the inter-domain engine, the NF topology information of the service response associated with the mask NF profile; and transmit the second service request and the NF topology information to a Service Communication Proxy (SCP) within the first network, wherein the SCP performs one of: NF selection or routing of the second service request based on the NF topology information.

Example 20 is the computer-readable storage medium of any previous or subsequent Example, wherein the processor-executable instructions cause the one or more processors to further execute processor-executable instructions stored in the computer-readable storage medium to: generate, by the inter-domain engine, a mask mapping of the mask NF profile to the service response; and store, by the inter-domain engine, the mask mapping and the service response for a validity period of the service response.

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate a first network function (NF) within a first network, wherein the first NF comprises an inter-domain engine, such that the processor-executable instructions, when executed by the one or more processors, direct the computing apparatus, to at least:
determine a first service request from a visitor consumer NF, wherein the first NF is in a first network and the visitor consumer NF is in a second network;
determine a service response based on the first service request, wherein the service response comprises NF topology information for furnishing the service request within the first network;
generate, by the inter-domain engine, a mask NF profile based on the service response;
generate, by the inter-domain engine, a mask service response based on the mask NF profile and the first service request; and
transmit the mask service response to the visitor consumer NF.

2. The computing apparatus of claim 1, wherein the processor-executable instructions, when executed by the one or more processors, further direct the computing apparatus to:
generate, by the inter-domain engine, a mask mapping of the mask NF profile to the service response;
determine, by the inter-domain engine, a validity period for the service response; and
store, by the inter-domain engine, the mask mapping and the service response for the validity period of the service response.

3. The computing apparatus of claim 1, wherein the processor-executable instructions to generate, by the inter-domain engine, the mask NF profile based on the service response, when executed by the one or more processors, further direct the computing apparatus to:
determine, by the inter-domain engine, one or more NF profile properties of the NF topology information from the service response; and
generate, by the inter-domain engine, the mask NF profile based on the one or more NF profile properties and endpoint information of the first NF.

4. The computing apparatus of claim 1, wherein the first service request comprises a discovery request and the service response comprises a discovery response, and the processor-executable instructions to determine the service response based on the first service request, when executed by the one or more processors, further direct the computing apparatus to:
forward the discovery request received from the visitor consumer NF to a Home Repository Function (NRF) in the first network; and
receive, from the NRF, the discovery response from the NRF, wherein the NRF determines the NF topology information for servicing the discovery request.

5. The computing apparatus of claim 1, wherein the processor-executable instructions, when executed by the one or more processors, further direct the computing apparatus to:
receive a second service request from the visitor consumer NF;
determine, by the inter-domain engine, the mask NF profile based on the second service request;
determine, by the inter-domain engine, the service response associated with the second service request based on the mask NF profile; and
route the second service request to one or more producer NFs in the first network based on the service response, wherein the one or more producer NFs furnish the second service request responsive to receiving the second service request.

6. The computing apparatus of claim 1, wherein the processor-executable instructions, when executed by the one or more processors, further direct the computing apparatus to:
receive a second service request from the visitor consumer NF;
map, by the inter-domain engine, the second service request to the mask NF profile;
determine, by the inter-domain engine, the NF topology information of the service response associated with the mask NF profile; and
transmit, by the first NF, the second service request and the NF topology information to a second NF within the first network, wherein the second NF performs one of:
NF selection; or
routing of the second service request based on the NF topology information.

7. The computing apparatus of claim 1, wherein the first NF comprises a Security Edge Protection Proxy (SEPP) within the first network.

8. A method comprising:
determining, by a first network function (NF), a first service request from a visitor consumer NF, wherein the first NF is in a first network and the visitor consumer NF is in a second network;
determining, by the first NF, a service response based on the first service request, wherein the service response comprises NF topology information for furnishing the service request within the first network;
generating, by an inter-domain engine of the first NF, a mask NF profile based on the service response;
generating, by the inter-domain engine, a mask service response based on the mask NF profile and the first service request; and
transmitting, by the first NF, the mask service response to the visitor consumer NF.

9. The method of claim 8, wherein the method further comprises:
receiving, by the first NF, a second service request from the visitor consumer NF;
determining, by the inter-domain engine, the mask NF profile based on the second service request;
determining, by the inter-domain engine, the service response associated with the second service request based on the mask NF profile;
determining, by the inter-domain engine, a producer NF in the first network for furnishing the second service request based on the service response; and
routing, by the first NF, the second service request to the producer NF, wherein the producer NF furnishes the second service request responsive to receiving the second service request.

10. The method of claim 8, wherein the method further comprises:
receiving, by the first NF, a second service request from the visitor consumer NF;
mapping, by the inter-domain engine, the second service request to the mask NF profile;
determining, by the inter-domain engine, the NF topology information of the service response associated with the mask NF profile; and
transmitting, by the first NF, the second service request and the NF topology information to a second NF within the first network, wherein the second NF performs one of:
NF selection; or
routing of the second service request based on the NF topology information.

11. The method of claim 8, wherein the method further comprises:
generating, by the inter-domain engine, a mask mapping of the mask NF profile to the service response; and
storing, by the inter-domain engine, the mask mapping and the service response.

12. The method of claim 8, wherein the mask NF profile comprises endpoint information for the first NF corresponding to the respective NF topology information in the service response.

13. The method of claim 8, wherein:
the first service request comprises a discovery request;
the service response comprises a discovery response; and
determining, by the first NF, the service response based on the first service request further comprises:
forwarding, by the first NF, the discovery request received from the visitor consumer NF to a Home Repository Function (NRF) in the first network; and
receiving, from the NRF, the discovery response from the NRF, wherein the NRF determines the NF topology information for servicing the discovery request.

14. The method of claim 8, wherein the first network comprises a first Public Land Mobile Network (PLMN) and the second network comprises a second PLMN.

15. The method of claim 8, wherein the first NF comprises a Security Edge Protection Proxy (SEPP) within the first network.

16. A computer-readable storage medium comprising processor-executable instructions, wherein the processor-executable instructions, in part, operate a first network function (NF) within a first network such to cause one or more processors to:
determine a first service request from a visitor consumer NF, wherein the visitor consumer NF is in a second network that is different than the first network;
determine a service response based on the first service request, wherein the service response comprises NF topology information for furnishing the service request within the first network;
generate, by an inter-domain engine, a mask NF profile based on the service response;
generate, by the inter-domain engine, a mask service response based on the mask NF profile and the first service request; and
transmit the mask service response to the visitor consumer NF.

17. The computer-readable storage medium of claim 16, wherein the processor-executable instructions to generate, by the inter-domain engine, the mask NF profile based on the service response cause the one or more processors to further execute processor-executable instructions stored in the computer-readable storage medium to:
determine, by the inter-domain engine, an NF profile comprising one or more NF profile properties; and
generate, by the inter-domain engine, the mask NF profile based on the one or more NF profile properties and endpoint information of the first NF, wherein the endpoint information of the first NF comprises at least one of:
a scheme associated with the first NF;
a Fully Qualified Domain Name (FQDN) associated with the first NF;
a port associated with the first NF; or
an Application Programming Interface (API) prefix associated with the first NF.

18. The computer-readable storage medium of claim 16, wherein the processor-executable instructions cause the one or more processors to further execute processor-executable instructions stored in the computer-readable storage medium to:
receive a second service request from the visitor consumer NF;
map, by the inter-domain engine, the second service request to the mask NF profile;
determine, by the inter-domain engine, the service response associated with the second service request based on the mask NF profile;
determine, by the inter-domain engine, a producer NF in the first network for furnishing the second service request based on the service response; and
route, by the first NF, the second service request to the producer NF, wherein the producer NF furnishes the second service request responsive to receiving the second service request.

19. The computer-readable storage medium of claim 16, wherein the processor-executable instructions cause the one or more processors to further execute processor-executable instructions stored in the computer-readable storage medium to:
receive a second service request from the visitor consumer NF;
map, by the inter-domain engine, the second service request to the mask NF profile;
determine, by the inter-domain engine, the NF topology information of the service response associated with the mask NF profile; and
transmit the second service request and the NF topology information to a Service Communication Proxy (SCP) within the first network, wherein the SCP performs one of: NF selection or routing of the second service request based on the NF topology information.

20. The computer-readable storage medium of claim 16, wherein the processor-executable instructions cause the one or more processors to further execute processor-executable instructions stored in the computer-readable storage medium to:
generate, by the inter-domain engine, a mask mapping of the mask NF profile to the service response; and
store, by the inter-domain engine, the mask mapping and the service response for a validity period of the service response.
